(19) United States
(12) Patent Application Publication
(10) Pub. No.: US 2013/0268282 A1
(43) Pub. Date: Oct. 10, 2013

(54) CALENDAR-BASED SCHEDULED THERAPY MEDIA SYSTEM AND METHOD

(71) Applicants: Karl HUGO, Portland, OR (US); Raquel HUGO, Portland, OR (US); Paul FUHS, Anchorage, AK (US); Robert OWENS, San Diego, CA (US)

(72) Inventors: Karl HUGO, Portland, OR (US); Raquel HUGO, Portland, OR (US); Paul FUHS, Anchorage, AK (US); Robert OWENS, San Diego, CA (US)

(21) Appl. No.: 13/439,794

(22) Filed: Apr. 4, 2012

(51) Int. Cl. G06Q 50/22

(52) U.S. Cl. 705/2

(57) ABSTRACT

A system and method for implementing and using a calendar-based schedule therapy media system. Such a system may be implemented using a web based collection of applications and software modules related to therapy and media for Traumatic Brain Injured (TBI) and similar symptom patients so as to enhance the recovery process and to assist health care providers and families in cooperatively managing treatment programs. This set of computer-based applications is designed to assist and enhance patient recovery through an exercise management tool to manage the recovery treatment program. Further, an application, executable on any computing device provides an all-in-one mobile resource to assist in fulfilling treatment regimens, and managing exercises with more independence. To further enhance the ability of a patient to self-direct various aspects of a session, the calendar based events may include network links to media items for assisting the patient by viewing or listening to video.

### BACKGROUND

People, the world over, suffer from various symptoms of Traumatic Brain Injury (TBI) that may typically result from highly stressful encounters or accidents. TBI, sometimes also known as intracranial injury, may occur when an external force causes trauma to the brain. TBI is a major cause of death and disability, and is a notable ailment of returning veterans from foreign wars and engagements.

Brain trauma may be caused by a direct impact or by acceleration alone. In addition to the damage caused at the moment of injury, brain trauma causes secondary injury, a variety of events that take place in the minutes and days following the injury. These processes, which include alterations in cerebral blood flow and the pressure within the skull, contribute substantially to the damage from the initial injury. As a result, TBI may cause a host of physical, cognitive, social, emotional, and behavioral effects. Recovery from these symptoms may range from complete recovery to permanent disability or death. Recent developments in diagnosis and treatment have decreased death rates and improved outcome. These include imaging techniques such as computed tomography and magnetic resonance imaging. Depending on the injury, treatment required may be minimal or may include interventions such as medications and/or surgery. Physical therapy, speech therapy, recreation therapy, and occupational therapy are often also employed for rehabilitation.

When therapy is prescribed, repetition of exercises at regular intervals becomes all the more important for recovery. However, because patients are suffering from a brain injury, remembering how to accomplish prescribed exercises, let alone remembering when to perform them in the first place, is problematic. A therapist may correctly diagnose and prescribe specific exercises that will help a patient recover, but because the therapist is unavailable to the patient at all times (e.g., three times a day as most therapy is prescribed), a patient may deviate from prescribed therapy because of failing to remember how to accomplish simple exercises or even forgetting that such exercise needs to be performed on a specific therapeutic schedule. In short, a person suffering from a brain injury may need external assistance with accomplishing even the simplest of therapies precisely because of the brain injury. Due to the brain injury, TBI patients are also commonly unable to provide feedback to therapists on their ability to perform and the effectiveness of the prescribed therapies, further inhibiting the therapist's ability to properly pace the therapy regimen.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a suitable computing device and environment for practicing various aspects of a calendar-based scheduled therapy media system and method according to an embodiment of the subject matter disclosed herein;

FIG. 2 is a block diagram of a system for a calendar-based scheduled therapy media system according to an embodiment of the subject matter disclosed herein;

FIG. 3 is a block diagram of software modules that comprise the calendar-based scheduled therapy media system and that may be executing on one or more computing devices of FIG. 2 according to an embodiment of the subject matter disclosed herein; and

FIG. 4 is a flow chart of a method for using the calendar-based therapy media system of FIG. 2 according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein may be directed to a system and method for implementing and using a calendar-based scheduled therapy media system. Such a system may be implemented using a web based collection of applications and software modules related to therapy and media for Traumatic Brain Injured (TBI) and similar symptom patients so as to enhance the recovery process and to assist health care providers and families in cooperatively managing treatment programs. This set of computer-based applications is designed to assist and enhance patient recovery through an exercise management tool to manage the recovery treatment program. Further, from a patient perspective, an application, executable on a mobile or connected computing device provides an all-in-one resource to assist in fulfilling treatment regimens, and managing exercises with more independence. To further enhance the ability of a patient to self-direct various aspects of a therapy session, the calendar based events may include network links to media items for assisting the patient by viewing or listening to video or other media for assisting correct physical, mental and speech performance of exercises.

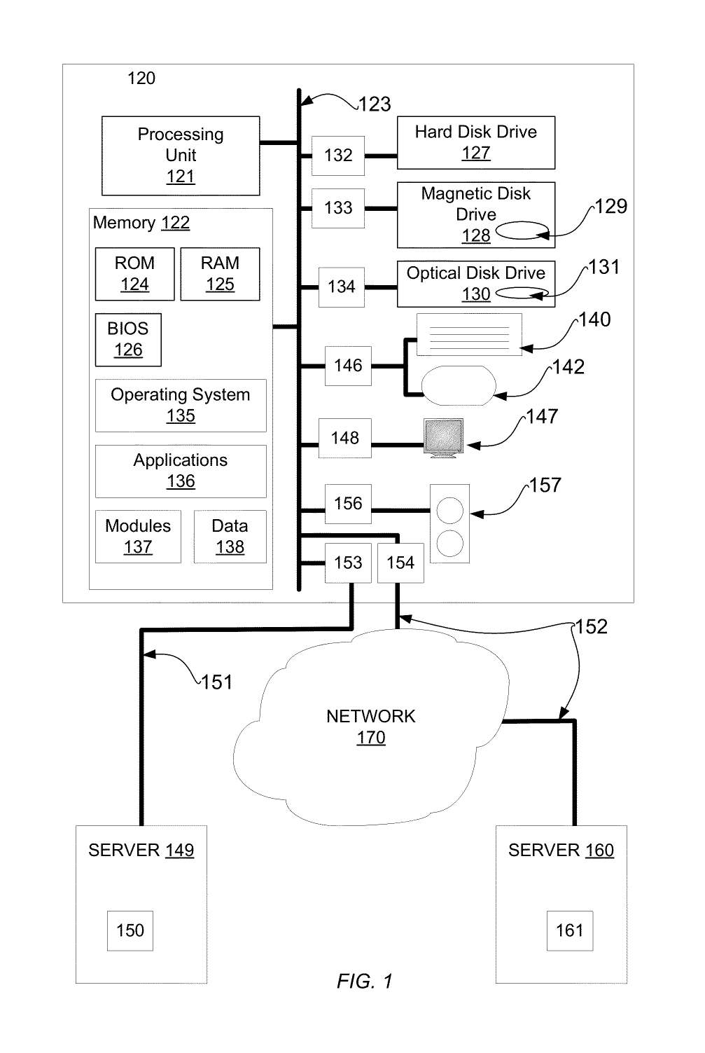

In this manner, a patient may have a convenient way to invoke assistive media for accomplishing sometimes difficult-to-remember exercises without the need of physician intervention (which may be difficult for patients who live in more remote areas). Further yet, the patient may provide instant feedback on exercises such that the physician may change a regimen to more accurately prescribe exercises to assist the patient without needing to meet with the patient. This, in turn, improves the efficiency and effectiveness of therapy sessions while also reducing the total cost of patient recovery. In an aggregate level, this system also provides physicians with a metric of patient usage and response across a large swath of patients. These and other aspects are described in greater detail below with respect to FIGS. 1-4.

FIG. 1 and the following discussion are intended to provide a brief, general description of a suitable computing environment in which the subject matter disclosed herein may be implemented. Although not required, aspects of a system and method for calendar-based scheduled therapy media will be described in the general context of computer-executable instructions, such as program modules, being executed by a computer device. Generally, program modules include routines, programs, objects, components, data structures, etc., that perform particular tasks or implement particular abstract data types. Such program module may be embodied in both a transitory and/or a non-transitory computer readable medium having computer-executable instructions. Moreover, those skilled in the art will appreciate that the invention may be practiced with other computer system configurations, including hand-held devices, cellular or mobile telephones, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote computer devices.

With reference to FIG. 1, an exemplary system for implementing the systems and methods disclosed herein includes a general purpose computing device in the form of a conventional personal computer 120, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory includes read only memory (ROM) 124 and random access memory (RAM) 125. A basic input/output system (BIOS) 126, containing the basic routines that help to transfer information between elements within the personal computer 120, such as during start-up, is stored in ROM 124. The personal computer 120 further includes a hard disk drive 127 for reading from and writing data to a hard disk, not shown, a magnetic disk drive 128 for reading from or writing data to a removable magnetic disk 129, and an optical disk drive 130 for reading from or writing data to a removable optical disk 131 such as a CD ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the personal computer 120. Although the exemplary environment described herein employs a hard disk, a removable magnetic disk 129 and a removable optical disk 131, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk 129, optical disk 131, ROM 124 or RAM 125, including an operating system 135, one or more application programs 136, other program modules 137, and program data 138. A user may enter commands and information into the personal computer 120 through input devices such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus, but may be connected by other interfaces, such as a parallel port, game port or a universal serial bus (USB). A monitor 147 or other type of display device is also connected to the system bus 123 via an interface, such as a video adapter 148. One or more speakers 157 are also connected to the system bus 123 via an interface, such as an audio adapter 156. In addition to the monitor and speakers, personal computers typically include other peripheral output devices (not shown), such as printers.

The personal computer 120 may also operate in a networked environment using logical connections to one or more remote computers, such as remote computers 149 and 160. Each remote computer 149 or 160 may be another personal computer, a server, a router, a network PC, a peer device or other common network node, and typically includes many or all of the elements described above relative to the personal computer 120, although only a memory storage device 150 or 161 has been illustrated in FIG. 1. The logical connections depicted in FIG. 1 include a local area network (LAN) 151 and a wide area network (WAN) 152, which may also include wireless network including but not limited to Global System for Mobil (GSM) and Code Division Multiple Access (CDMA) 152.2. Such networking environments are commonplace in offices, enterprise-wide computer networks, intranets, Internet and the mobile networks. As depicted in FIG. 1, the remote computer 149 communicates with the personal computer 120 via the local area network 151. The remote computer 160 communicates with the personal computer 120 via the wide area network 152. The remote computer 160 communicates with the personal computer 120 via the wireless network.

When used in a LAN networking environment, the personal computer 120 is connected to the local network 151 through a network interface or adapter 153. When used in a WAN networking environment, the personal computer 120 typically includes a modem 154, Network Interface Card (NIC) or other means for establishing communications over the wide area network 152, such as the Internet. The modem 154, which may be internal or external, is connected to the system bus 123. In a networked environment, program modules depicted relative to the personal computer 120, or portions thereof, may be stored in the remote memory storage device. It will be appreciated that the network connections shown are exemplary and other means of establishing a communications link between the computers may be used.

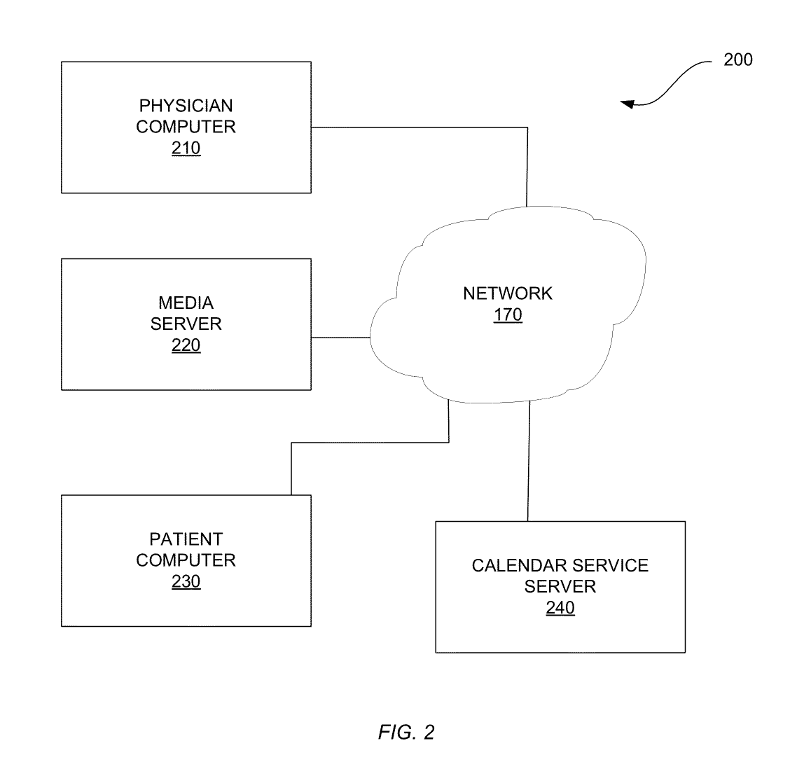

With such a computing environment as described with respect to FIG. 1, a calendar-based scheduled therapy media system having various embodiments as discussed herein may be practiced and used. FIG. 2 shows a high-level block diagram of a calendar-based scheduled media therapy system 200. The system 200 includes a number of computing devices that may be similar to the computing device of FIG. 1. Thus, the various computing systems may include a physician computer 210, a media server computer 220, a patient computer 230 and a calendar service server computer 240. Each of these computing devices may be communicatively coupled with each other through a computer network 170, e.g., the internet. Further, any of these computing devices may be a personal computer, a desktop computer, a server computer, a laptop computer, a personal computing device, a smart phone or any other suitable computing environment.

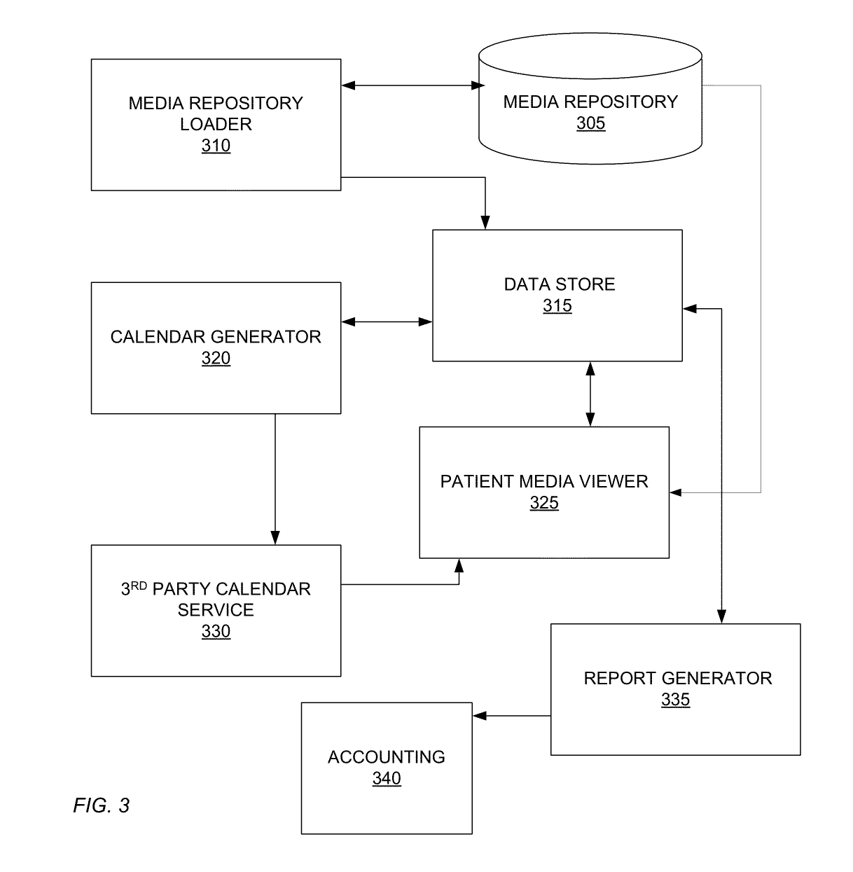

In general, the calendar-based scheduled therapy media system 200 includes methods and software modules (no individual software modules shown in FIG. 2) for providing a computer-based system for a therapist to create a regimen of presentations of rehabilitation therapy media for a given patient and defining the scheduled presentation of said media to the patient. This system 200 presents a patient with a way to view scheduled therapy media and to specify feedback on the media for the therapist or physician to review for the purpose of refining the patient's prescribed therapy. As such, the various software modules that may be used with the overall system may be distributed across these various computing device platforms in the system of FIG. 2. In FIG. 3, described below, the various software modules are shown without regard to a specific platform upon which each module may reside. That is, from the perspective of the software modules in the system 200, they may reside and be executed on any platform or computing device; however, as will be more readily apparent during the discussion of each software module, the particular computing device in which it may be executing may be optimal with one location over another.

In this context, these various software modules may be used in conjunction with at least four software applications. A first application may be executed at a patient computer 230 or a physician computer 210 and used for accessing and viewing media on a scheduled timeframe. A second application may be executed at a physician computer 210 and is used for creating a calendar and linking media to scheduled events. A third application may be a cross-platform application executed across several computing devices for loading media and descriptive attributes into a network-accessible file repository. Lastly, a fourth application may be executed at a physician computer 210 for viewing patient performance data in reports or for exporting data to accounting and other systems. Although described herein as separate applications, these delineations may not be needed as each application may operate across the platforms and interact with each other in ways that obscure the lines between delineated applications. As such, the next paragraphs will focus on software modules for accomplishing specific tasks within the overall system across the multiple platforms.

FIG. 3 shows a block diagram of software modules that comprise the calendar-based scheduled therapy media system and that may be executing on one or more computing devices of FIG. 2 according to an embodiment of the subject matter disclosed herein. In the context of the diagram of FIG. 3, the following discussion may be loosely associated with a life cycle of use of the calendar-based scheduled therapy media system. Thus, in an initial state, a media repository module 305 may have stored therein all videos, static images, animations, audio recordings, cognitive scripts and other media commonly used with and accessed by a media viewer module 325. Each item in the media repository module 305 may typically be associated with a unique identifying name or code. As a result, metadata about the media items may be used when media items are copied from the media repository module 305 to other software modules in the system 200.

The media items may typically include video presentations of a person accomplishing a therapeutic maneuver. However, the media items may also include static image that may be manipulated to see the therapeutic maneuver from differing points of view. Further yet, the media items may include music features along with video features. In one embodiment, not only is there a presentation of a video of how to accomplish a therapeutic maneuver, and also an associated song playing concurrent with the video. The song may be a song of the patient's choice and perhaps a particularly inspiring or motivating song for the patient. Further yet, the music aspects may include interactive features such that a patient may be able to sing-along with the music in a karaoke-like setting. Words to the song may even be streaming across the bottom of video display. Patients may access a music module containing familiar songs along with the lyrics presented on screen in a karaoke like setting. It has been reported that identifying with familiar music and singing along with it is often a starting point for patient rehabilitation. Adding music, and even interactive music, to the media presentation assists a patient with accomplishing recovery.

A second software module, a media repository loader 310, may be used to load new media items into the media repository module 305. Additionally, a media repository loader 310 may be used to update or delete media items from the media repository module 305. Thus, in an embodiment, the media repository loader stores the location of each media item with an Universal Resource Identifier (URI) along with metadata for describing and organizing loaded media items in the data store 315.

Another software module used in the system 200 includes a calendar generator 320. Using this software module, a physician or administrator may use methods and procedures provided in calendar generator 320 to identify and select media items as well as specify how the selected media items may be used within the context of the calendar-based scheduled therapy media system. That is, selected media items may be assigned across a calendar date range and be associated with exercise repeat counts per session and number of exercise sessions per day, per week. Further, each exercise may also be associated with an exercise priority. In this manner, a prescribed therapy routine may be established by a physician such that a calendar of scheduled therapy exercises grounded in media items is established.

Once the calendar generator has established a series of exercises across a date range, the calendar generator 320 may then interact with a 3^{rd} party calendar service software module 330 (e.g., Microsoft Outlook™, Google™, etc.) so as to allow the calendar service provided by the third party to contain scheduled events that contain links to the media items and associated meta data contained in data store 315. The 3^{rd} party calendar service can be engaged with various computing devices across the network. That is, once a series of calendar-based exercises is established in the 3^{rd} party service, regular 3^{rd} party service calendar reminders, texts, emails, and all other calendar-based communication may be at a user's disposal for improving the likelihood of accomplishing the scheduled therapy.

As a patient receives reminders or otherwise engages the media items at the prescribed time, a media viewer module 325 may be used on the patient computing device to view the media item. Thus, the media item may be a series of images or a short movie of how to accomplish an exercise. Further, the media item may also include interactive features such as the ability of a user to rotate static images to see differing views or to provide instant feedback about the relative difficulty or ease of a particular exercise. In some embodiments, the media viewer 325 may begin automatically at the specified time and date in the calendar of scheduled exercises. Thus, when starting, the Media Viewer 325 uses URIs linked to calendar events to retrieve media items from the data store 315 to display exercises specified for that date/time.

As the patient is performing or has completed the prescribed exercises, the patient may then have an opportunity to provide instantaneous feedback. Further, the patient may also indicate that specific exercise have been completed at specified times. Such feedback data may be stored in the data store 315. In this manner, a report generator 335 is configured to generate a report based upon feedback data that is stored in the data store 315. This report may be sent to a physician such that the physician can monitor the patient's progress as well as assimilate patient feedback about relative difficulty or ease of the various exercises. Further, the report generator 335 may also automatically generate a billing to an accounting software module 340 such that the completion of another round of therapeutic exercises triggers a billing event.

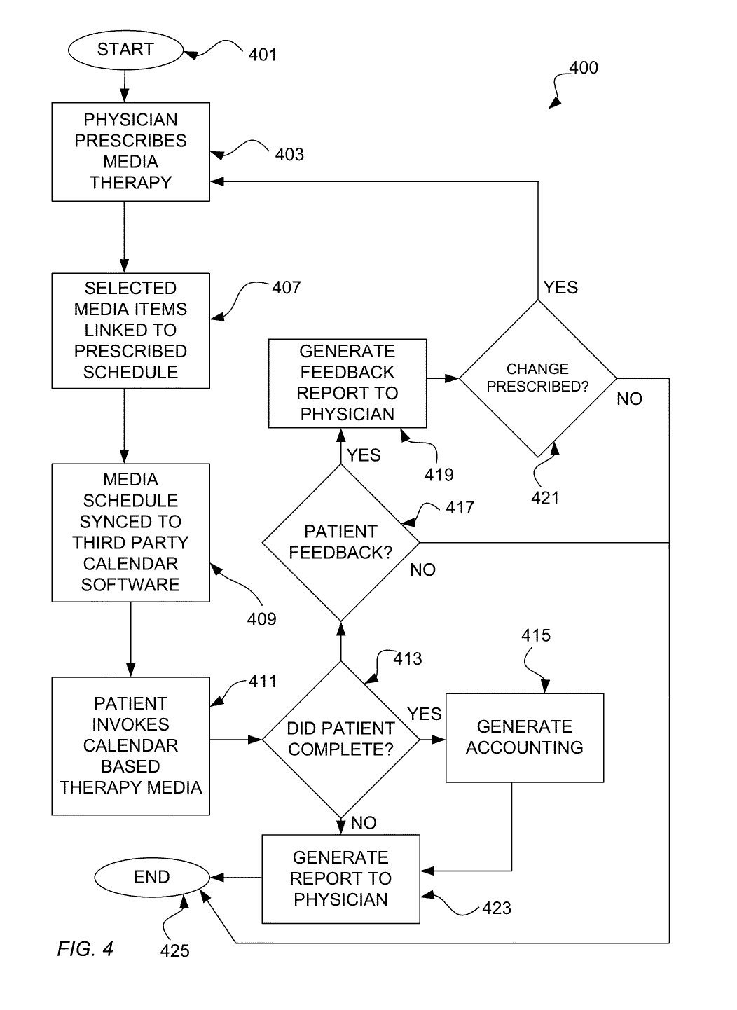

FIG. 4 is a flow chart 400 of a method for using the calendar-based therapy media system of FIG. 2 according to an embodiment of the subject matter disclosed herein. This flowchart exemplifies one embodiment of an overall method for using such a system, however, several offshoot methods and sub-methods herein may also be gleaned from the flowchart of FIG. 4. Further, several method steps may be omitted from this flow chart 400 in an effort to present an overview of the entire method. These omitted flowchart steps may include authentication steps and security measures prevalent throughout all communications expressly stated or implied herein.

Thus, the method may begin at step 401. A physician may, at step 403, assess a patient's symptoms and needs via conventional methods (e.g., and office visit and a typical initial meeting with a physician). Thus, the physician, employing his or her medical background and experience, may prescribe a regimen of physical and/or mental therapy exercises for a patient to follow according to a therapy schedule. Thus, at step 403, the prescribed calendar-based therapy may be input into a computing device (such as a physician's computer 210 of FIG. 2), such that the prescribed therapy exercises may be associated with specific media items regarding the specific prescribed therapy exercises. That is, if the physician prescribes a leg lift exercise, once input into the computing device, the prescribed therapy exercise may also be associated with a video (i.e., a media item) of a person doing the leg lift exercise.

In a next step 407, the physician may initiate the compilation of the prescribed therapy sessions into the data store 315 (FIG. 3). All physician prescribed selections of media items contained in a media repository 305 and referenced by a URI may be stored, as described above with respect to FIG. 3, in the data store 315. The new or updated file or record that specifies the patient therapy regimen and all associated meta data relating to each media item and it's specific use, event time, number of repeats and therapy instructional comments pertaining to a patient's therapy may be stored in data store 315. Thus, the media repository items associated with the prescribed therapy as well as associated with the patient are now stored in a media and data store and ready to be scheduled. In this step 407, a calendar generator 320 (FIG. 3) may populate a therapy calendar associated with the patient with the prescribed therapy and associated media items. Thus, a calendar-based scheduled therapy media regimen may now be stored at the data store and associated with the prescribing physician as well as the patient.

At the direction of either the physician or the prescribing therapist, the stored regimen may then by synchronized with a third-party calendaring service at step 409. As such, a third-party calendaring service may be used to establish reminders and populate locally stored calendars (such as on a smart phone or patient computer) such that the scheduled therapy is melded into a patient's existing calendaring service(s). Additionally the 3^{rd} party calendaring service may be instructed to send electronic messages via common platforms (emails, texts, SMS, etc.) directly to a patient's device to remind about a scheduled therapy session.

In one embodiment, the third-party calendar services may be provided by a variety of third-party companies who host calendars that support standard iCal calendar data formats. In addition, external data stores may be utilized for program data, media storage, and user preferences.

At the next step, a patient may begin a scheduled therapy session at the behest of calendar based reminders or prompts. In one embodiment, a media viewer may be executed on a local patient computing device (e.g., a personal computer, a smart phone, etc.). This may be accomplished by using an application stored and executed on this local computing device such as a common web browsers including Safari™, Firefox™, or Chrome™. With the web browser, the patient may access the media viewer to view exercise instructions and make comments or feedback on each exercise. The physician can access the media viewer, the calendar generator, the report generator and the media repository loader.

Such an application provides a number of features available to the patient via the application. Thus, via a typical calendar display in a user-interface, various prescribed therapies may be shown within the context of the calendar. Thus, in one embodiment, the titles of media items associated to the current therapy that may be scheduled are shown and may include a link to the media item stored in the media repository 305. If the patient engages the link, the media item may be downloaded to the local computing device for playback. Further, the application may also include controls for starting, stopping, repeating and selecting or automatically displaying the next exercise material in the current calendar of therapies.

In another feature of the patient application, the patient may select feedback options for each therapeutic exercise that is shown. Feedback options may include ratings on a scale of one to ten, for example, ratings for difficulty, ratings for value, and ratings for helpfulness of the media item. The feedback data and other metrics of patient performance may be then used to generate a report to the physician.

Another feature of the automated configuration of the 3^{rd} party calendar for the patient support is the ability to specify reminders. Thus as a scheduled therapy time approaches, a reminder may be executed such as sending a text message to a smart phone or to play a wave file of a reminder chime. Further, at the time of the scheduled therapy, the automated reminders for a therapy session for a patient may contain links or soft-buttons that when pressed open a web browser and navigating to a URL for the media viewer tool and then begin playback of an associated media item. Such automation assists a patient with accomplishing the therapy as the patient does not need to remember how to open the application/browser and navigate to the media materials.

If the patient indicates that a particular therapy exercise has been completed at a decision step 413, a billing event may be generated at step 415. This automatically generated billing event may cause an electronic message to be sent to a third-party billing system wherein the completion of the therapy exercise is indicative of an office visit and/or therapy session. Thus, as a patient completes each therapy session, a simple indication from the patient via an application executing at the patient's computer may invoke the billing aspects of the therapy session. Furthermore, the method may also generate a report to the physician at step 423 indicative of completion of the therapy session (or indicate that the therapy session was not completed at the decision step 413.

Concurrent with the therapy session, the patient may also provide instantaneous feedback on therapy exercises at decision step 417. If there is no feedback from the patient, the method records that exercises was accessed, time spent on exercise and other attributes to report to the physician. However, the patient may provide meaningful feedback about specific exercises, relative difficulty or ease of specific exercises, and other critical feedback that may allow a physician to further tailor the regimen to fit the needs of the patient. Thus, at step 419, a feedback report may be delivered to the physician allowing the physician an opportunity to change the regimen at step 421. If there is a change to be made, then the process repeats with the loading of a new regimen and new media items. The loading of a new regimen is transparent to the patient and they are only notified of and when the next exercise is to be completed. If no changes are made than this method ends at step 425.

With such a system and method in place as described above with respect to FIGS. 2-4, several features and advantages may be evident.

One advantage of collecting feedback data about specific therapy and specific media items about the specific therapy, physicians may garner aggregate data about therapies and media across various patients without compromising the confidential physician-patient relationship. Feedback data may be assembled without regard to corresponding patients. Thus, aggregating feedback data provides a tool for multiple physicians to communicate and cooperatively manage prescribed media and exercises for a single patient, or multiple patients over time.

Another advantage arises with a cost savings in billing procedures. By automating electronic communication with billing software, the calendar-based therapy media system can streamline the procedure for initiating and consummating billing for therapy sessions. As some billing software only allows for billing once a therapy session has been completed, this system allows for immediate indication that a specific therapy session has been completed. Further, feedback can be either viewed in different report formats or used as a data source for patient billing records that can be fed to an accounting system.

Another advantage arises with the time savings for the primary caregivers of the patient by saving time to record completion of exercises and time savings of not being required to submitted billing reports of exercise completion. Thereby enabling primary caregiver to refocus said saved time on greater and more effective care for the patient.

The calendar-based therapy media system may also include additional features in various software modules for realizing additional functionality. In one feature, all communications between different computing devices may be via a secured connection that utilizes common authentication measures as well as Pretty Good Privacy (PGP) encryption or similar industry standard encryption. Such authenticated and encrypted communications ensures compliance with the Health Insurance Portability and Accountability Act (HIPAA).

Another feature, typically associated with the media viewer aspects, may include a “Panic Button” for a patient. Often times, a patient suffering from TBI may become more easily confused than a person who does not suffer from TBI. As a result, sometimes even simple tasks may cause confusion and panic in a patient. By providing a prominent and easily engaged software-based button in the media viewer display. If a patient activates the panic button, a relatively instantaneous electronic notification (e.g., a text message, an email, etc.)may be sent to a physician or caregiver so as to alert such a person to the location and need for assistance of the patient.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

1. A system, comprising:
a server computer having a plurality of media items stored thereon, each media item corresponding to a therapeutic exercise;
a first computing device, associated with a physician, configured to allow the physician to prescribe a regimen of therapeutic exercises according to a schedule, each therapeutic exercise in the regimen associated with a corresponding media item stored on the server computer; and
a second computing device, associated with a patient, configured to receive media items prescribed by the physician according to the schedule, the second computing device further configured to automatically execute the media items and to allow the patient to provide feedback to the physician about the media items; and
a calendar-service computing device communicatively coupled to the first and second computing devices, the calendar-service computing device configured to populate a calendar service with the schedule of therapeutic exercises according to the prescribed regimen.

2. The system of claim 1, wherein the first computing device and second computing device each comprise one of the group including: a personal computer, a smart phone, a laptop computer, a tablet computer, a personal data assistant, and a desktop computer.

3. The system of claim 1, further comprising a computer network communicatively coupled to the server computer, the first computing device and the second computing device, the computer network operable to facilitate communication between the server computer, the first computing device, and the second computing device.

4. (canceled)

5. The system of claim 1, further comprising a software module executing on at least one computing device configured to provide security and authentication suited to comply with the Health Insurance Portability and Accountability Act.

6. The system of claim 1, further comprising a second server computer configured to provide billing services for the physician, the second server computer communicatively coupled to the second computing device such that a billing event is automatically initiated at the second server computer in response to feedback from the second computing device.

7. A non-transitory computer readable medium having computer-executable instruction thereon, the computer-executable instruction operable to cause a computer to:
receive a schedule of prescribed therapeutic exercises and populate a calendar with the schedule;
retrieve at least one media item for each prescribed therapeutic exercise from a server computer;
automatically display, on a computing device, the at least one media item at a scheduled time associated with the prescribed therapeutic exercise; and
facilitate user feedback in response to the media being displayed.

8. The computer readable medium of claim 7 having further computer-executable instructions for generating a report to a physician in response to the feedback.

9. The computer readable medium of claim 7 having further computer-executable instructions for generating a billing event at a billing computer in response to the feedback.

10. The computer readable medium of claim 7 having further computer-executable instructions for redisplaying the media item in response to user input.

11. The computer readable medium of claim 7 having further computer-executable instructions for alerting a physician through an urgent electronic communication that a user has initiated a panic feedback.

12. The computer readable medium of claim 7 having further computer-executable instructions for changing the prescribed regimen of therapeutic exercises in response to the feedback.

13. The computer readable medium of claim 7 having further computer-executable instructions for generating a link to a retrieved media items in a calendar software module executing on the computing device.

14. The computer readable medium of claim 7 wherein the at least one media item comprises a media item from the group including: a video file, and audio file, a video file with audio, a series of static images, and interactive presentation, a song file, a karaoke song file, and an interactive textual document.

15. A method, comprising:
prescribing at least one therapeutic exercise to a patient and selecting at least one media item stored in a computer repository of media items to be associated with the at least one therapeutic exercise;
schedule the at least one therapeutic exercise in a computer-based calendar service such that the scheduled therapeutic exercise appears in an entry in the calendar as a link to the associated media item; and
electronically communicating the schedule to a patient; and
automatically executing the associated media item according to the schedule.

16. The method of claim 15, further comprising:
receiving feedback from the patient about the scheduled therapeutic exercise; and
changing the prescribed therapeutic exercise in response to the feedback.

17. The method of claim 15, further comprising:
receiving feedback from the patient about the scheduled therapeutic exercise; and
automatically initiating a billing event in response to the feedback.

18. The method of claim 15, further comprising:
receiving feedback from the patient about the scheduled therapeutic exercise; and
automatically generating a report to the physician in response to the feedback.

19. The method of claim 15, further comprising:
receiving feedback from the patient about the scheduled therapeutic exercise; and
automatically assimilating the feedback with information about other similarly-situated prescription and feedback physician/patient relationships.

20. The method of claim 15, further comprising generating at least one electronic reminder communication to the patient about a scheduled therapeutic exercise.
